(19) United States
(12) Patent Application Publication
(10) Pub. No.: US 2006/0292067 A1
(43) Pub. Date: Dec. 28, 2006

(54) Hydrogen generation catalysts and methods for hydrogen generation

(76) Inventors: Qinglin Zhang, Manalpan, NJ (US); Ying Wu, Red Bank, NJ (US); Gregory M. Smith, Marlboro, NJ (US); Michael Binder, Brooklyn, NY (US)

Correspondence Address: DICKSTEIN SHAPIRO LLP, 1825 EYE STREET NW, Washington, DC, 20006-5403, US

(21) Appl. No.: 11/167,607

(22) Filed: Jun. 28, 2005

(51) Int. Cl. C01B 3/02

(52) U.S. Cl. 423/648.1

(57) ABSTRACT

Supported catalyst methods are provided to promote hydrogen generation from the hydrolysis of boron hydrides. The methods use a supported catalyst which is a supported metallic mixture comprising a first transition metal selected from the group consisting of cobalt, ruthenium, zinc, molybdenum, manganese, titanium, tin, cadmium, and iridium, in an amount of from about 0.1 to about 20% by weight, and a second metal selected from the group consisting of cobalt, ruthenium, zinc, molybdenum, manganese, titanium, tin, cadmium, boron, and iridium, in an amount of from about 0.05 to about 25% by weight of the supported catalyst.

### FIELD OF THE INVENTION

The present invention relates to catalysts and methods for the catalytic generation of hydrogen from, for example, aqueous chemical hydride solutions.

### BACKGROUND OF THE INVENTION

Chemical hydrides are known hydrogen storage materials characterized by relatively high gravimetric hydrogen storage density. Chemical hydrides, such as alkali metal hydrides and metal borohydrides, can generate hydrogen through a hydrolysis reaction with water. For these chemical hydrides, the gravimetric hydrogen densities range from about 4 to about 9% by weight. Sodium borohydride (NaBH₄) is of particular interest because it can be dissolved in alkaline water solutions with virtually no reaction until it contacts a catalyst. In this case, the stabilized alkaline solution of sodium borohydride is referred to as “fuel” or “fuel solution.”

Various hydrogen generation systems have been developed for the production of hydrogen gas by the metal catalyzed hydrolysis of aqueous sodium borohydride fuel solutions. One current technology for hydrogen generation from stabilized sodium borohydride solutions involves feeding the fuel solution at ambient temperature to a catalyst bed packed with a catalyst to promote hydrogen generation.

Activity, durability and cost of the catalyst are the major barriers for meeting commercial specifications. Improvements in catalyst activity would enable higher reactor throughput, therefore reducing the required total volume of catalyst bed, and consequently the static liquid hold-up volume of the hydrogen generation system. A durable catalyst must ensure that such high throughput is maintained over a relatively long period of time, thus eliminating the need to over-design the amount of catalyst used in order to compensate for the reduced activity of the aged catalyst bed. Ultimately, improvements in catalyst activity are needed to achieve overall reduced system volume and higher system hydrogen storage densities.

In addition, catalysts for hydrogen generation systems are needed that ensure fast dynamic system control and high fuel conversion over the lifetime of the system. Durable catalysts that tolerate hot caustic solutions and that deliver high performance under catalyst reactor conditions, such as temperatures above 100° C. and pressures exceeding 50 psig (pounds-force per square inch gauge), also are needed, as well as systems and methods for generating hydrogen gas employing such durable catalysts.

### BRIEF SUMMARY OF THE INVENTION

The present invention provides supported catalysts that promote the hydrolysis of fuel solutions to produce hydrogen. The supported catalysts can be supported metallic catalysts comprising a support substrate carrying a mixture of at least a first transition metal selected from the group consisting of cobalt, ruthenium, zinc, molybdenum, manganese, iron, titanium, tin, cadmium, nickel, and iridium, and at least a second component selected from the group consisting of cobalt, ruthenium, zinc, molybdenum, manganese, iron, boron, titanium, tin, cadmium, nickel, and iridium. Thus, in one embodiment the catalyst according to the invention is bimetallic, although additional catalyst components, including but not limited to, a third transition metal may optionally be included.

The invention also provides a hydrogen generation supported catalyst, comprising a mixture of at least first and second metals, wherein each of the first and second metals is different and is independently selected from the group consisting of cobalt, ruthenium, zinc, molybdenum, manganese, titanium, tin, cadmium, and iridium.

The invention further provides a hydrogen generation supported catalyst, comprising a support substrate; and a metallic mixture on the support, wherein the mixture comprises a first metal in an amount of about 0.05 to about 20% by weight, and a second metal in an amount of about 0.01 to about 25% by weight of the supported catalyst. In a preferred embodiment, the invention provides a ruthenium/cobalt hydrogen generation catalyst, comprising a support; and ruthenium in an amount of about 0.1 to about 2% by weight, and cobalt in an amount of about 1 to about 5% by weight, based on the total weight of the supported catalyst. In particularly preferred embodiments the supported catalyst has a BET surface area greater than typically seen for common metallic wires, sheets, or fibers, for example, and preferably in the range of about 5 to 20 m²/g.

In another embodiment the invention provides a system and method of generating hydrogen gas, comprising providing an aqueous fuel solution containing a material selected from the group consisting of boranes, polyhedral boranes, borohydride salts, and polyhedral borane salts; and contacting the aqueous fuel solution with a hydrogen generation catalyst comprising a support, a first metal selected from the group consisting of cobalt, ruthenium, zinc, molybdenum, manganese, iron, boron, titanium, tin, cadmium, and iridium, the first metal being present in an amount of about 0.05 to about 20% by weight of the hydrogen generation catalyst; and a second metal selected from the group consisting of cobalt, ruthenium, zinc, molybdenum, manganese, titanium, tin, cadmium, and iridium to produce hydrogen gas, the second metal being present in an amount of about 0.01 to about 25% by weight of the hydrogen generation catalyst.

The accompanying drawings together with the detailed description herein illustrate these and other embodiments and serve to explain the principles of the invention. Other features and advantages of the present invention will also become apparent from the following description of the invention which refers to the accompanying drawings.

### BRIEF DESCRIPTION OF THE DRAWINGS

FIG. 1 illustrates the relation between fuel conversion and fuel space velocity for five samples of a ruthenium/cobalt catalyst according to the present invention; and

FIG. 2 illustrates the relation between reactor temperature and time at two reactor pressures using a ruthenium/cobalt catalyst according to the present invention.

### DESCRIPTION OF THE INVENTION

The present invention provides durable, highly active supported catalysts and systems for hydrogen generation from, for example, the hydrolysis of boron hydride compounds. The systems of the present invention can serve to enhance the hydrolysis reactions of boron hydride compounds to produce hydrogen gas. The hydrolysis reaction shown in equation (1) below is characteristic of borohydride compounds:
MBH₄+2H₂O→MBO₂+4 H₂+heat Equation 1

The high purity hydrogen produced by the above hydrolysis reaction is suitable for a variety of end use applications, including, but not limited to, use in proton exchange membrane (PEM) fuel cells, as the gas stream is warm and humidified due to the exothermic nature of the reaction. In particular, PEM fuel cells require a humid hydrogen gas stream to prevent dehydration of the membrane and resultant loss of electrical efficiency.

The preferred supported catalysts of the present invention are highly active, durable and can be used repeatedly without significant loss of catalytic activity. The supported catalysts of the present invention can comprise various mixtures of metals selected from the group consisting of cobalt, ruthenium, zinc, molybdenum, manganese, iron, boron, titanium, tin, cadmium, nickel, and iridium. Preferably, the supported catalysts of the present invention contain bimetallic metal mixtures comprising a first component and a second component. In an exemplary embodiment, the first component is a transition metal selected from the group consisting of cobalt, ruthenium, zinc, molybdenum, manganese, iron, titanium, tin, cadmium, nickel, and iridium and is present in an amount of from about 0.05 to about 20% by weight, preferably from about 1 to about 10% by weight, and most preferably from about 1 to about 5% by weight. The second component in this embodiment is a metal selected from the group consisting of cobalt, ruthenium, zinc, molybdenum, manganese, iron, boron, titanium, tin, cadmium, nickel, and iridium and is present in an amount of from about 0.01 to about 25% by weight, preferably from about 0.1 to about 2% by weight.

Mixtures of cobalt-ruthenium, cobalt-zinc, cobalt-manganese, and cobalt-molybdenum are particularly preferred. Most preferably, the cobalt is present in an amount ranging from about 0.05 wt-% to about 20 wt-%, preferably from about 1 wt-% to about 10 wt-%, and most preferably from about 1 to 5 wt-%, and the second component is present in an amount ranging from about 0.01 wt-% to 25 wt-%, preferably from about 0.1 wt-% and 2 wt-%. All weight percentages herein are expressed as a percent of the total weight of the supported catalyst, i.e., the support and the metallic mixture, which may be deposited on or impregnated in the support.

Typically, the most reactive metals for initiating the hydrolysis of boron hydrides are the relatively expensive Group VIII metals, such as platinum, rhodium, and ruthenium, and thus catalysts comprising such metals can be a major contributor to the cost of a hydrogen generating system. As shown in Table 1 below, a higher loading of a less reactive metal (e.g., 3 wt-% cobalt) provides a similar hydrogen generation rate as compared to a lower loading of a more reactive metal (e.g., 0.5 wt-% ruthenium). Table 1 further demonstrates that appropriate combinations of less reactive metals, which are often a tenth or a hundredth of the price of platinum, rhodium, and ruthenium, can offer effective hydrogen generation rates. Accordingly, catalyst components and loadings can be selected to meet the operating demands and cost constraints of particular hydrogen generation systems, given the teachings herein.

TABLE 1
Catalyst Activity at 30° C. with 20
wt % NaBH₄ and 3 wt % NaOH fuel solutions

| | Mean Hydrogen Generation Rate |
|---|---|
| Ni- Supported Catalyst | 10⁻⁵ L/s/g |
| 3 wt-% Co | 14.3 |
| 0.5 wt-% Ru | 17.3 |
| 3 wt-% Co/3 wt-% Mo | 34.5 |
| 3 wt-% Co/3 wt-% Mn | 36 |
| 3 wt-% Co/0.5 wt-% Ru | 40.1 |
| 3 wt-% Co/3 wt-% Zn | 55.7 |
| 3 wt-% Co/1.2 wt-% Ru | 61 |

The above weight percentages are calculated based on the total weight of the individual component with respect to the total weight of all catalyst components including the support material. The term “hydrogen generation catalyst” as used herein means the metal mixture together with the support substrate or carrier on which the mixture is deposited, impregnated, or otherwise carried. The catalytically active species may include the metals in their reduced elemental state or in high oxidation states as found in compounds such as metal oxides or metal borides. Analytical techniques such as inductively coupled plasma-mass spectrometry (ICP-MS) and energy dispersive X-ray analysis (EDX) are useful as they permit measurement of the elements without regard to oxidation state.

The support or carrier may be any substrate that allows deposition of metals on its surface, or impregnation of metals, and which will not readily break apart or erode from the rapid formation of hydrogen gas on the surface and in internal pores. The use of a support is preferred as it allows easy separation of the catalyst from the reaction media. In addition, when a support or carrier is employed, the rate of hydrogen generation can be controlled by regulating the contact with the catalyst, as disclosed in U.S. Pat. No. 6,534,033 entitled “System for Hydrogen Generation,” the entire disclosure of which is hereby incorporated herein.

The carrier is preferably chemically inert in caustic solutions at pressures up to 200 psig or more and temperatures up to 200° C. or more. Suitable carriers include (1) activated carbon, coke, or charcoal; (2) ceramics and refractory inorganic oxides such as titanium dioxide, zirconium oxide, cerium oxides, used individually or as mixtures thereof; (3) metal foams, sintered metals and metal fibers or composite materials of nickel and titanium; and (4) perovskites with the general formula ABO₃, where A is a metallic atom with a valence of +2 and B is a metallic atom with a valence of +4.

The supported catalysts of the present invention may be formed by any suitable deposition method, including, for example, deposition on and/or impregnation of active elements, or mixtures of active elements, on a support. This deposition may be followed by a further surface treatment, including reduction with a reducing agent (hydrogen for example, although other reducing agents including sodium borohydride can be used), calcination, or oxidation with an oxidizing agent (such as, but not limited to, air and oxygen). Suitable methods are disclosed in, for example, U.S. Pat. No. 6,534,033. In an exemplary embodiment, an impregnated support is prepared by mixing 50 g of 50:50 nickel powder:nickel fiber composite pads, cut into 0.25″×0.25″ chips, with about 30 mL of an aqueous solution containing 6.31 g CoCl₂.6H₂O and 1.431 g RuCl₃.H₂O, heating the mixture to about 70° C. and evaporating the water until completely dry. The resulting supported catalyst is then heated in a tube furnace at about 240° C. under a 20 mL/min hydrogen (4% in nitrogen) flow for about 3 hours at atmospheric pressure. The final catalyst has a nominal loading of about 1.2% Ru by weight and about 3% Co by weight (assuming final total catalyst weight equals the Ni-pad plus the Ru metal plus the Co metal). Various other methods for depositing or impregnating a transition metal mixture on a carrier may be employed as known in the art or determined by one skilled in the art given the teachings herein.

The supported catalysts of the invention also may be employed in the form of pellets, monoliths, chips, or other physical forms suitable for use in a fixed-bed, trickle-bed, or other reactor, such as the one described in co-pending U.S. patent application Ser. No. 10/741,032, entitled “Catalytic Reactor for Hydrogen Generator Systems,” the entire disclosure of which is hereby incorporated herein.

For highly efficient hydrogen generation from the hydrolysis of boron hydrides, it is preferred that the catalyst have a high surface area as a means to increase the number of potentially available and reactive catalytic sites. The term “high surface area” as used in this application refers to a BET surface area of about 5 to about 100 m²/g, preferably between about 7 to about 25 m²/g, and most preferably of about 10 m²/g of the supported catalyst. The supported catalyst is preferably porous with an average pore radius between 5 and 50 Å, more preferably between 15 and 35 Å, and most preferably between about 20 and 30 Å. A total pore volume is preferably about 5 to about 100 mL/g, more preferably about 30 to about 70 mL/g.

The terms “boron hydride” or “boron hydrides” as used herein include boranes, polyhedral boranes, and anions of borohydrides or polyhedral boranes, such as those provided in co-pending U.S. patent application Ser. No. 10/741,199, entitled “Fuel Blends for Hydrogen Generators,” filed Dec. 19, 2003, the entire disclosure of which is hereby incorporated herein. Suitable boron hydrides include, without intended limitation, the group of borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, among others, where M is a cation selected from the group consisting of alkali metal cations, alkaline earth metal cations, aluminum cation, zinc cation, and ammonium cation, and n is equal to the charge of the cation. For the above-mentioned boron hydrides, M is preferably sodium, potassium, lithium, or calcium.

The following example further describes and demonstrates features of the present invention. The example is given solely for illustration purposes and is not to be construed as a limitation of the present invention.

### EXAMPLE

A catalyst comprising 0.6 wt-% ruthenium and 2 wt-% cobalt supported on a nickel metallic mat containing pressed nickel fibers and sintered nickel particles in a 40:60 ratio was used to evaluate durability and hydrogen generation activity.

Bulk and surface chemical composition were measured by ICP-MS and EDX to determine any catalyst degradation during use. Resulting data are summarized in Tables 2 and 3 below.

Fresh catalysts were subject to fuel treatments conducted under atmospheric pressure and using a 20 wt-% sodium borohydride and 3 wt-% NaOH fuel solution at about 70° C., as a way to simulate multi-cycle usage of the catalyst. For each test, 200 mL of fuel solution was added to a reactor immersed in a water bath preheated to about 30° C., and the reactor system thoroughly purged with hydrogen. Catalyst was then added to the reactor and stirred with a magnetic stirrer for 0.5 hours. Rate of hydrogen generation and reaction temperature were measured. Activity of the catalyst was evaluated based on initial rate of hydrogen generation at 30° C. under the controlled conditions. Catalyst durability can be evaluated by comparison of activities obtained after the catalyst was subjected to different fuel treatment cycles.

TABLE 2
Chemical composition on weight basis

| | ICP: Bulk Composition, wt-% | | | | EDX: Surface composition, wt-% | | | | |
|---|---|---|---|---|---|---|---|---|---|
| Catalyst “age” | Ru | Co | B | Fe | Ru | Co | Ni | Fe | O |
| Unused | 0.7 | 2.04 | 0.0 | 0.66 | 9.8 | 10.2 | 43.0 | 0.5 | 36.6 |
| 2 fuel treatments | 0.7 | 1.65 | 0.7 | 0.64 | 0.6 | 17.8 | 43.5 | 0.6 | 37.7 |
| 35 fuel treatments | 0.68 | 2.03 | 0.77 | 0.74 | 0.8 | 16.4 | 49.9 | 0.8 | 32.2 |

TABLE 3
Chemical composition on mole basis

| | ICP: Bulk, mol:mol | | | EDX: Surface: mol; mol | | | |
|---|---|---|---|---|---|---|---|
| Catalyst Usage | Ru:Co | Ru:Co:B | Ru:Co:Fe | Ru:Co | Ru:Co:Ni | Ru:Co:O | Ru:Co:Ni:O |
| Unused | 1:5 | 1:5:0 | 1:5:1.7 | 1:2 | 1:2:8 | 1:2:24 | 1:2:8:24 |
| 2 fuel treatments | 1:4 | 1:4:9 | 1:4:1.7 | 1:51 | 1:51:125 | 1:51:397 | 1:51:125:397 |
| 35 fuel treatments | 1:5 | 1:5:11 | 1:5:2 | 1:35 | 1:35:107 | 1:35:254 | 1:35:107:254 |

The ICP-MS analysis revealed that bulk composition is close to nominal loading of 0.6 wt-% Ru and 2 wt-% Co. No significant changes in bulk composition were noted before and after fuel treatments. Initially, minor ruthenium metal leaching from the surface is observed, but the surface concentrations remain relatively stable after 2 and 35 fuel treatments.

The hydrogen generation activity of the catalyst was evaluated with a packed bed tubular reactor (0.842″ internal diameter×7″ long) under various fuel flow conditions. In operation, a fuel pump fed the fuel (20 wt-% sodium borohydride and 3 wt-% NaOH aqueous solution) from a storage tank to a reactor packed with a catalyst according to the present invention. The fuel flow rate was monitored by using a scale and a timer. Upon contacting the catalyst bed, the fuel solution generated hydrogen gas and sodium metaborate as shown in equation (1) above. The hydrogen and metaborate solution were separated in a gas-liquid separator, and the humidified hydrogen then cooled down to room temperature after passage through a heat exchanger and a drier. The steady-state hydrogen evolution rate was monitored with a mass flow meter. The operating conditions for the reactor tests are summarized in Table 4 below.

TABLE 4
EXPERIMENTAL CONDITIONS FOR EVALUATION
OF REACTOR PERFORMANCE

| Performance metrics | Operating conditions |
|---|---|
| Reactor startup | Fuel flow rate: 20 g/min |
| | Start at room temperature and 55 psig |
| Reactor throughput | Various fuel flows, ranging from |
| | 0.1-1.5 min⁻¹ space velocity |
| | Steady-state operation at each flow rate |
| | 55 psig |

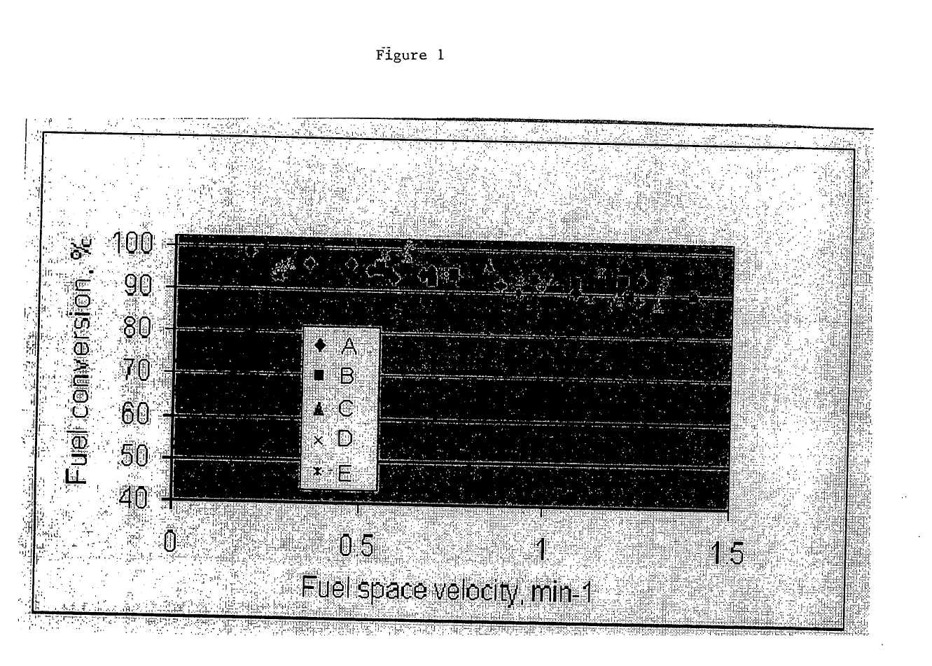

FIG. 1 illustrates the relation between the fuel conversion and the fuel throughput (or space velocity) for five samples A, B, C, D and E of a ruthenium/cobalt catalyst according to the present invention. The reactor was started at ambient conditions at a constant liquid fuel space velocity and operated continuously at 55 or 80 psig for about 6 to 8 hours before reactor shutdown. Following shutdown, the reactor was flushed with water to remove residual fuel inside the reactor. Fuel conversions of at least 90% were achieved over a wide range of fuel flow rates. A high reactor throughput greater than 680 standard liters of hydrogen per minute (SLPM H₂) per liter reactor volume was achieved with fuel conversions greater than 92%.

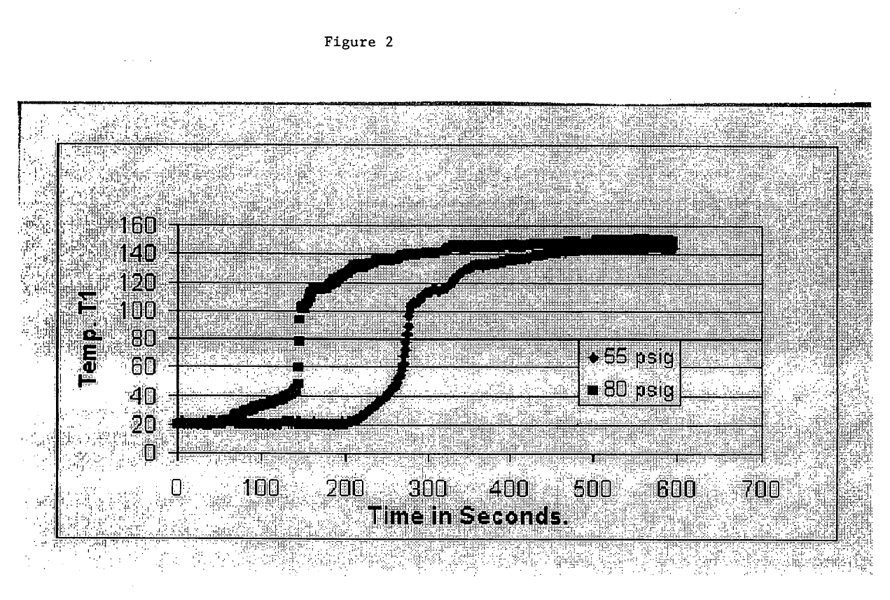

FIG. 2 illustrates the relation between reactor temperature and time at different pressures for a catalytic reactor containing a ruthenium/cobalt catalyst according to the present invention. Fast reactor start up dynamics are preferred in the design of a hydrogen storage system. According to another embodiment of the present invention, reactor startup profiles were measured at a constant fuel flow rate of 20 g/min at 55 and 80 psig pressure, as higher pressures lead to a faster reactor startup. As shown in FIG. 2, ruthenium/cobalt supported catalysts according to the present invention demonstrate rapid startup profiles.

Although the invention has been described in detail in connection with the exemplary embodiments, it should be understood that the invention is not limited to the above disclosed embodiments. Rather, the invention can be modified to incorporate any number of variations, alterations, substitutions, or equivalent arrangements not heretofore described, but which are commensurate with the spirit and scope of the invention. Accordingly, the invention is not limited by the foregoing description, but is only limited by the scope of the appended claims and equivalents thereof.

What is claimed as new and desired to be protected by Letters Patent of the United States is:

1. A method of generating hydrogen gas, comprising:
providing an aqueous fuel solution comprising a material selected from the group consisting of boranes, polyhedral boranes, borohydride salts, and polyhedral borane salts; and
contacting the aqueous fuel solution with a hydrogen generation catalyst comprising a support, a first metal selected from the group consisting of cobalt, ruthenium, zinc, molybdenum, manganese, titanium, tin, cadmium, and iridium, the first metal being present in an amount of about 0.05 to about 20% by weight of the hydrogen generation catalyst; and a second metal selected from the group consisting of cobalt, ruthenium, zinc, molybdenum, manganese, titanium, tin, cadmium, boron, and iridium to produce hydrogen gas, the second metal being present in an amount of about 0.01 to about 25% by weight of the hydrogen generation catalyst.

2. The method of claim 1, wherein the first metal is cobalt and the second metal is ruthenium.

3. The method of claim 1, wherein the first metal is present in an amount of about 1 to about 10% by weight.

4. The method of claim 1, wherein the first metal is present in an amount of about 1 to about 5% by weight.

5. The method of claim 1, wherein the second metal is present in an amount of about 0.1 to about 2% by weight.

6. The method of claim 1, wherein conversion of the aqueous fuel solution with the hydrogen generation catalyst is conducted with a conversion rate of at least 80%.

8. The method of claim 1, wherein the second metal is present in an amount of about 0.1 to about 2% by weight of the supported catalyst.

9. The method of claim 1, wherein the first metal is cobalt.

10. The method of claim 9, wherein the second metal is selected from the group consisting of ruthenium, manganese, molybdenum, and zinc.

11. The method of claim 1, wherein the support contains a material selected from the group consisting of activated carbon, coke, and charcoal.

12. The method of claim 1, wherein the support contains at least one refractory inorganic oxide.

13. The method of claim 1, wherein the support contains a metal in the form of a foam, sintered particle, fiber, monolith, or a mixture thereof.

14. The method of claim 1, wherein the support is in the form of a perovskite of the formula ABO₃, wherein A is a metallic atom with a valence of +2 and B is a metallic atom with a valence of +4.

15. The method of claim 1, wherein the catalyst has a BET surface area of about 5 to about 25 m²/g.

16. The method of claim 1, wherein the catalyst has a BET surface area of about 10 m²/g .

17. The method of claim 1, wherein the supported catalyst has pores and an average pore radius of about 5 to about 50 Angstroms.

18. The method of claim 1, wherein the supported catalyst has pores having a volume of about 5 to 100 mL/g.
